(19) United States
(12) Patent Application Publication
(10) Pub. No.: US 2007/0129950 A1
(43) Pub. Date: Jun. 7, 2007

(54) Speech act-based voice XML dialogue apparatus for controlling dialogue flow and method thereof

(76) Inventors: Kyoung Hyun Park, Seo-gu (KR); Sang Hun Kim, Yuseong-gu (KR)

Correspondence Address: LADAS & PARRY LLP, 224 SOUTH MICHIGAN AVENUE, SUITE 1600, CHICAGO, IL, 60604, US

(21) Appl. No.: 11/545,159

(22) Filed: Oct. 10, 2006

(30) Foreign Application Priority Data
Dec. 5, 2005 (KR) 10-2005-0117580
Jun. 29, 2006 (KR) 10-2006-0059135

(51) Int. Cl. G10L 21/00

(52) U.S. Cl. 704/270.1

(57) ABSTRACT

Provided is a voice dialogue interface field that is related to a speech act-based voice Extensible Markup Language (VoiceXML) dialogue apparatus for controlling a dialogue flow and a method thereof. The speech act-based VoiceXML dialogue apparatus includes a dialogue manager for performing dialogue management by extracting speech act information from a speaker's speech; and a VoiceXML interpreter for performing a dialogue control by determining response speech act information based on the speech act information and an associated speech act-based VoiceXML document.

### CROSS-REFERENCE TO RELATED APPLICATION

This application claims priority to and the benefit of Korean Patent Application Nos. 2005-117580, filed Dec. 5, 2005, and 2006-59135, filed Jun. 29, 2006, the disclosures of which are incorporated herein by reference in their entirety.

### BACKGROUND

1. Field of the Invention

The present invention relates to voice interfacing, and more particularly, to a speech act-based Voice Extensible Markup Language (VoiceXML) dialogue apparatus for controlling a dialogue flow and a method thereof.

2. Discussion of Related Art

Voice Extensible Markup Language (VoiceXML) is a speech-based standard language used on the Internet. VoiceXML implements a web-based service scenario on a VoiceXML platform corresponding to an Interactive Voice Response (IVR) apparatus and provides the service through voice over a telephone. This corresponds to an Internet service that implements and provides the web-based service scenario on a personal computer through HyperText Markup Language (HTML).

VoiceXML is a markup language that is capable of controlling data on the web using the voice over the telephone, and is currently used in dialogue systems. Also, in view of dialogue management, since VoiceXML controls a dialogue flow, a developer can control the dialogue flow in a way that was impossible in the conventional dialogue system.

However, since VoiceXML describes a dialogue scenario based on speech, it is limited to describing the dialogue flow.

For example, if VoiceXML is preprogrammed to describe a subsequent dialogue in response to a spoken “Hello,” it does not continue the dialogue when another word such as “Hi” that has equivalent meaning but is different from the preprogrammed “Hello” is spoken.

For easier understanding, exemplary embodiments will be described with reference to the accompanying drawings.

FIG. 1 illustrates an example scenario of a vocal weather search in a conventional VoiceXML dialogue system.

Referring to FIG. 1, first, a user calls a robot named “Sunny,” and the robot responds, “How may I help you?” Then, the user asks “How is the weather in Daejeon today?” and the robot conducts a search and provides the user with the requested information by saying, “It is fine in Daejeon today.”

However, in the above scenario, the VoiceXML system provides information on the weather only when the user phrases the question exactly as “How is the weather in Daejeon today?” The system does not recognize the request, and thus cannot provide information on weather when phrased differently, such as “Please let me know the weather in Daejeon” or “Is it fine today in Daejeon?”

This is because the dialogue content, “How is the weather in Daejeon today” is preprogrammed in the VoiceXML document. The VoiceXML dialogue system does not continue the dialogue when the user's speech “How is the weather in Daejeon today?” does not match a sentence recorded in the VoiceXML document.

As described above, the conventional VoiceXML system has been widely commercialized since the developer can easily prepare a dialogue scenario and apply it to the dialogue system even without knowing the internal structure of the dialogue system. However, since VoiceXML itself describes the dialogue content, it is limited in processing dialogue.

Consequently, the conventional system is currently used in system-initiated dialogue fields such as limited information providing systems and reservation systems.

As described above, the conventional VoiceXML dialogue system has the following problems.

First, since the conventional VoiceXML dialogue system defines the dialogue flow on the basis of certain preprogrammed speech, it is inflexible and unable to continue the dialogue when the user's speech varies from the preprogrammed speech.

Second, since the conventional VoiceXML dialogue system defines the dialogue flow, it is not easy to change the dialogue field or the dialogue flow within the dialogue field.

### SUMMARY OF THE INVENTION

The present invention is directed to a Voice Extensible Markup Language (VoiceXML) dialogue apparatus and a method thereof capable of controlling a dialogue flow by employing VoiceXML and Dialogue Description Markup Language (DDML).

One aspect of the present invention provides a speech act-based VoiceXML dialogue apparatus for controlling a dialogue flow including: a dialogue manager for performing dialogue management by extracting speech act information from a speaker's speech; and a VoiceXML interpreter for performing a dialogue control by determining response speech act information based on the speech act information and an associated speech act-based VoiceXML document.

The dialogue manager may include: a speech recognition unit for recognizing the speaker's speech; a dialogue management unit for parsing the recognized speech data to extract speech act information therefrom and generating a response sentence on the basis of the response speech act information transferred from the VoiceXML interpreter; and a voice synthesis unit for synthesizing the response sentence and responding to the speaker.

Preferably, the speech act-based VoiceXML dialogue apparatus may further include a Scenario2DDML module for generating a DDML document corresponding to a dialogue scenario extracted from a dialogue database (DB); and a DDML2VoiceXML module for converting the DDML document into a speech act-based VoiceXML document and storing it in a web server.

Preferably, the speech act-based VoiceXML dialogue apparatus may further include a DDML editor for editing the DDML document.

The DDML document may represent a dialogue flow on a state basis, said state including a speech object, speech act information, and a target.

Another aspect of the present invention provides a speech act-based VoiceXML dialogue method, including the steps of: (a) recognizing a speaker's speech and outputting the recognized result; (b) parsing the recognized speech and extracting speech act information therefrom; (c) loading a speech act-based VoiceXML document corresponding to the extracted speech act information from a web server and generating response speech act information based on the speech act information and the speech act-based VoiceXML document; and (d) generating a response sentence corresponding to the response speech act information, synthesizing the sentence, and responding to the speaker.

Preferably, the method may further include the steps of extracting a dialogue scenario from a dialogue database (DB) in a specific field in off-line mode; extracting speech act information from the extracted dialogue scenario and generating the DDML document that reflects multiple dialogue flows; and converting the DDML document into the speech act-based VoiceXML document and storing the document in the web server.

Preferably, the method may further include the step of editing the DDML document.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates a sample scenario of a weather search dialogue in a conventional Voice Extensible Markup Language (VoiceXML) dialogue system;

FIG. 2 illustrates the configuration of a speech act-based VoiceXML dialogue system for controlling a dialogue flow according to an exemplary embodiment of the present invention;

FIG. 3 illustrates an example of Dialogue Description Markup Language (DDML) implemented in the VoiceXML dialogue apparatus according to an exemplary embodiment of the present invention;

FIG. 4 illustrates examples of Document Type Definition (DTD) of the DDML according to an exemplary embodiment of the present invention;

FIG. 5 is a flowchart illustrating a speech act-based VoiceXML dialogue method for controlling a dialogue flow according to an exemplary embodiment of the present invention;

FIG. 6 illustrates a part of the DDML reflecting multiple dialogue flows used in the VoiceXML dialogue method according to an exemplary embodiment of the present invention;

FIG. 7 illustrates a part of speech act-based VoiceXML document according to an exemplary embodiment of the present invention.; and

FIG. 8 illustrates a speech act-based VoiceXML dialogue method for controlling a dialogue flow according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various modified forms. Therefore, the following embodiments are provided for complete disclosure of the present invention and to fully inform the scope of the present invention to those of ordinary skill in the art.

A speech act-based VoiceXML dialogue system for controlling a dialogue flow and a method thereof will be described with reference to the accompanying drawings.

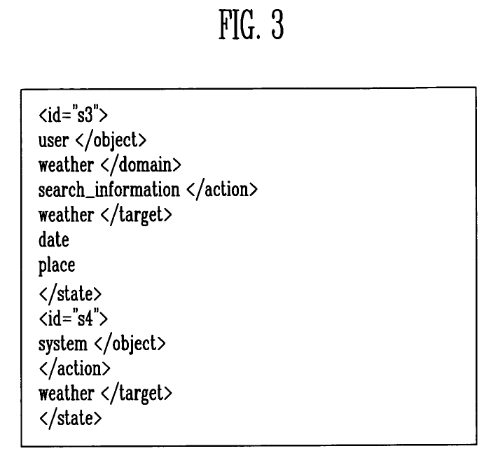

FIG. 2 illustrates the configuration of a speech act-based VoiceXML dialogue system for controlling a dialogue flow according to an exemplary embodiment of the present invention.

As illustrated in FIG. 2, the VoiceXML dialogue system is largely divided into a VoiceXML dialogue portion 100 and an off-line portion 200. Here, the off-line portion 200 is a block for providing necessary information to control a dialogue flow in an off-line mode. Most operations are performed in the VoiceXML dialogue portion 100 in the VoiceXML dialogue apparatus.

The VoiceXML dialogue portion 100 includes a dialogue manager 110 for performing dialogue management by extracting speech act information from a speaker's speech; and a VoiceXML 120 interpreter for performing a dialogue control by determining response speech act information based on the speech act information and an associated speech act-based VoiceXML document.

Specifically, the dialogue manager 110 includes a speech recognition unit 112 for recognizing the input speech; a dialogue management unit 114 for parsing the recognized speech to extract speech act information therefrom and generating a response sentence on the basis of response speech act information transferred from the VoiceXML interpreter 120; and a voice synthesis unit 116 for synthesizing the response sentence generated by the dialogue management unit 114 and responding to the speaker. The VoiceXML interpreter 120 loads the associated speech act-based VoiceXML document 212 stored in the web server 210 on the basis of the speech act information transferred from the dialogue management unit 114 and advances dialogue by determining response speech act information based on the speech act-based VoiceXML document 212 and the speech act information.

The off-line portion 200 includes a Scenario2DDML module 250 for generating a DDML document 220 based on dialogue scenario 230 extracted from a dialogue database (DB) in a specific field and a DDML2VoiceXML module 240 for converting the DDML document 220 into the speech act-based VoiceXML document 212 and storing it in the web server 210.

Here, when the generated DDML document 220 derivates from the dialogue flow that a developer requests or more detailed dialogue flow control is required, the DDML can be modified using a DDML editor (not shown).

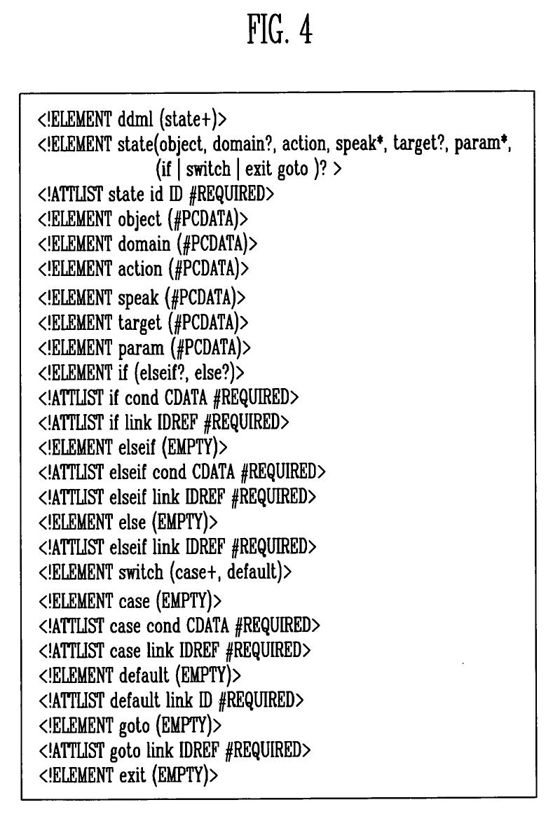

FIG. 3 illustrates an example of a DDML document that can be implemented in the VoiceXML dialogue system according to an exemplary embodiment of the present invention. It represents weather search scenario

As illustrated in FIG. 3, the DDML represents each dialogue on a state basis, and each state includes a speech object (“<object>”), speech act information (“<action>”), a target (“<target>”), and additional information.

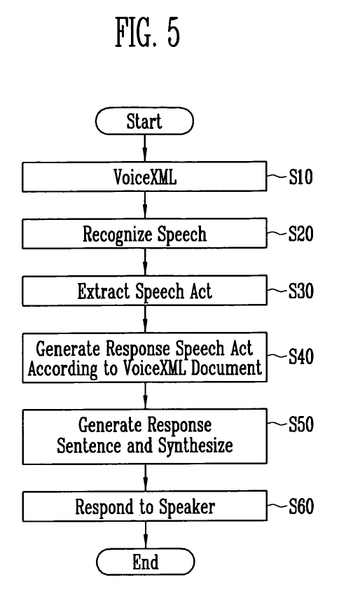

As described above, the DDML is a markup language for describing a dialogue flow on the basis of speech act information. Thus, the DDML document 220 may be automatically generated from a dialogue scenario 230 according to Document Type Definition (DTD) of the DDML as illustrated in FIG. 4. In addition, the developer may easily change and modify the DDML document using the DDML editor in the off-line mode.

A speech act-based VoiceXML dialogue method for controlling a dialogue flow according to the present invention will be described in detail below with reference to the accompanying drawings.

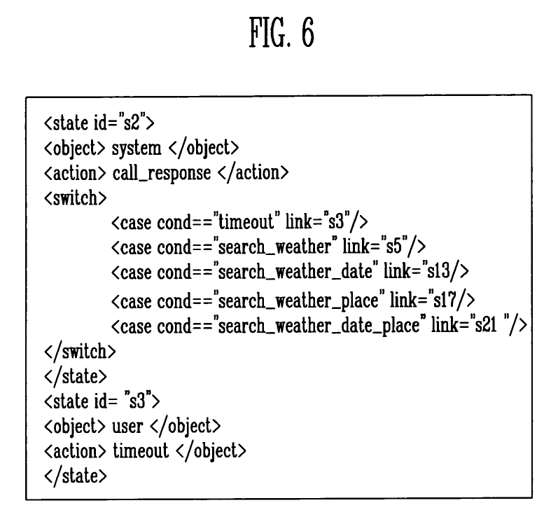

FIG. 5 is a flowchart illustrating a speech act-based VoiceXML dialogue method for controlling a dialogue flow according to an exemplary embodiment of the present invention.

Referring to FIG. 5, first, when a speaker speaks, the speech recognition unit 112 recognizes the speech and transfers the recognized result to the dialogue management unit 114.

Sequentially, the dialogue management unit 114 parses the result of the recognized speech, extracts speech act information therefrom, and transfers the extracted speech act information to the VoiceXML interpreter 120.

Then, the VoiceXML interpreter 120 loads an assoicated speech act-based VoiceXML document stored in a web server on the basis of the speech act information transferred from the dialogue management unit 114 and advances the dialogue based on the VoiceXML document and the speech act information by transferring speech act information corresponding to a response sentence, i.e., response speech act information, to the dialogue management unit 114.

Here, the speech act-based VoiceXML document 212 is generated by the following processes on the basis of the speech act information.

First, a dialogue scenario is extracted from a DB in a specific field.

Then, the speech act information is extracted from the extracted dialogue scenario through a Scenario2DDML 126 to thereby generate a DDML document 220 expressed in DDML reflecting multiple dialogue flows on the basis of the DDML DTD as illustrated in FIG. 4. At this time, when the generated DDML document deviates from the dialogue flow that a developer requests or more detailed dialogue flow control is required, the developer may edit the DDML document using the DDML editor.

Here, the editing of the DDML document is required to flexibly process the dialogue. In other words, since the dialogue scenario is extracted from the dialogue DB, it is likely that only general dialogue flows are described in the DDML document. Therefore, it is necessary to edit it to handle unexpected dialogue and the specific-field dependent dialogue cases.

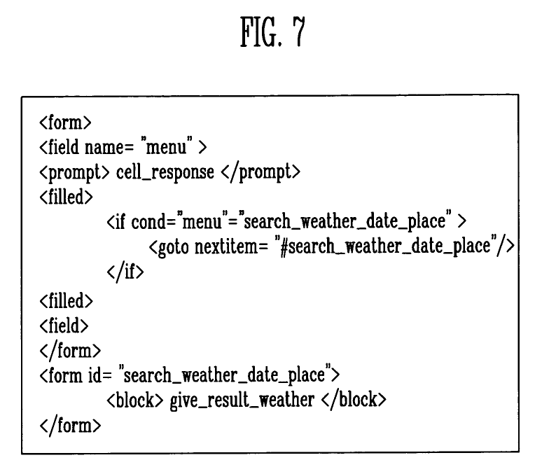

FIG. 6 illustrates a part of DDML reflecting multiple dialogue flows according to an exemplary embodiment of the present invention.

The DDML document 220 generated as above is converted into the speech act-based VoiceXML document 212 through the DDML2VoiceXML module 240, and is stored in the web server 210.

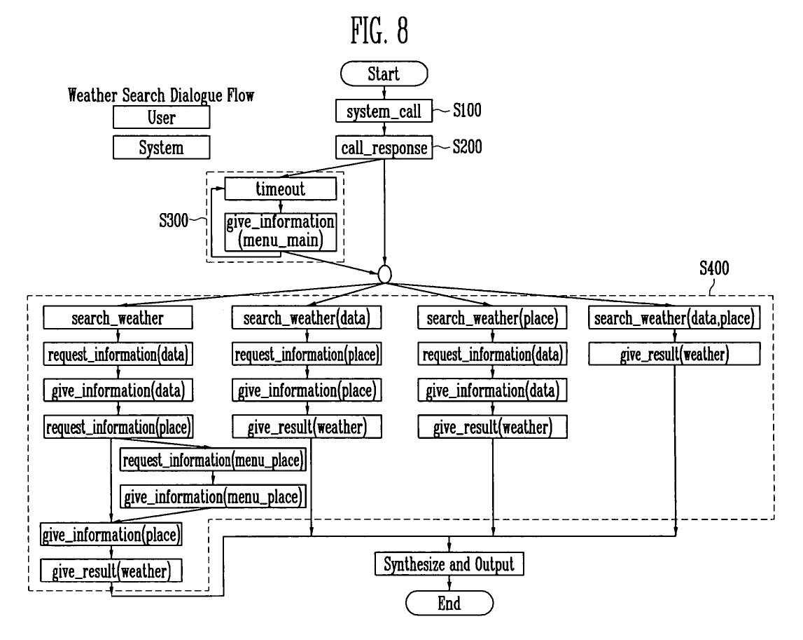

FIG. 7 illustrates a part of speech act-based VoiceXML document according to an exemplary embodiment of the present invention.

The dialogue management unit 114 generates a response sentence based on the response speech act information transferred from the VoiceXML interpreter 120, and transfers the response sentence to the voice synthesis unit 116.

Finally, the voice synthesis unit 116 synthesizes the response sentence and responds to the speaker.

FIG. 8 illustrates a speech act-based VoiceXML dialogue method for controlling a dialogue flow according to an exemplary embodiment of the present invention, which illustrates multiple dialogue flows that mainly deal with a weather search.

Referring to FIG. 8, when the speaker calls a robot, a dialogue manager 110 extracts the speech act information (system_call) from dialogue content, and transfers it to a VoiceXML interpreter 120 (S100).

Then, the VoiceXML interpreter 120 returns response speech act information (call_response) to the dialogue manager 110, and waits for next speech act information (S200).

Next, the speaker says “Please inform me of the weather in Daejeon” and the dialogue manager 110 again extracts speech act information (search_weather_date_place) relating to the weather search (S300).

At this time, since dialogue flows may diverge according to user's reaction in actual dialogue, the DDML should be able to describe multiple dialogue flows.

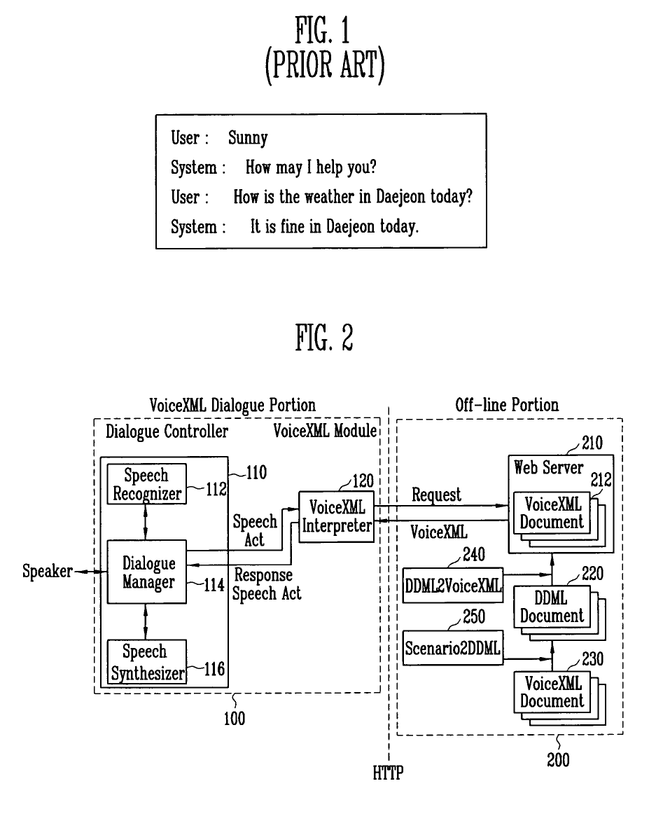

For example, in the weather search dialogue as illustrated in FIG. 1, while a user may ask the question, “How is the weather in Daejeon today?” specifying weather, time, and place, the user may alternatively phrase the question to specify only weather and time (“How is the weather today?”), weather and place (“How is the weather in Daejeon?”), or simply weather (“Could you please inform me of the weather?”).

As described above, although the above questions have the speaker's same intention, weather search, since information included in each question is different from each other, each should have a different dialogue flow.

Accordingly, as illustrated in FIG. 8, the DDML defines an element and an attribute for controlling dialogue divergence, such as if, switch, goto, link, etc., to describe multiple dialogue flows

Therefore, the VoiceXML interpreter 120 loads the VoiceXML document converted from the DDML document in which the multiple dialogue flows are described, processes the corresponding dialogue, and returns the response speech act information to the dialogue manager 110 (S400).

The dialogue management unit 114 generates a response sentence corresponding to the response speech act information, and transfers the generated response sentence to the voice synthesis unit 116.

As described above, the speech act-based VoiceXML can control a dialogue flow more flexibly than in the conventional method. In other words, in the conventional VoiceXML system, if only “Please inform me of the weather today” is described in the VoiceXML, the dialogue can only proceed when the speaker says those exact words, “Please inform me of the weather today.” However, if speech act information is employed, various expressions that include the same speech act, such as “How is the weather today?”, “Will it be fine today, too?” etc., can be allowed. This enables a more flexible dialogue flow, and the user may feel more comfortable with the system.

As described above, a speech act-based VoiceXML dialogue system for controlling a dialogue flow and a method thereof have the following effects.

First, since the speech act-based VoiceXML dialogue system and method thereof according to the present invention can process dialogue in various fields, the user can feel more comfortable with the system. And, the present invention may be applied to various fields.

Second, since VoiceXML only controls a dialogue flow in the present invention, dialogue management and dialogue flow (dialogue scenario) control are performed independently, so that a developer can flexibly manage the dialogue flow.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A speech act-based voice Extensible Markup Language (VoiceXML) dialogue apparatus, comprising:
a dialogue manager for performing dialogue management by extracting speech act information from a speaker's speech; and
a VoiceXML interpreter for performing a dialogue control by determining response speech act information based on the speech act information and an associated speech act-based VoiceXML document.

2. The speech act-based VoiceXML dialogue apparatus according to claim 1, wherein the dialogue manager comprises:
a speech recognition unit for recognizing the speaker's speech;
a dialogue management unit for parsing the recognized speech data to extract speech act information therefrom and generating a response sentence on the basis of the response speech act information transferred from the VoiceXML interpreter; and
a voice synthesis unit for synthesizing the response sentence and responding to the speaker.

3. The speech act-based VoiceXML dialogue apparatus according to claim 1, further comprising:
Scenario2DDML module for generating a DDML document corresponding to a dialogue scenario extracted from a dialogue database (DB); and
DDML2VoiceXML module for converting the DDML document into a speech act-based VoiceXML document and storing it in a web server.

4. The speech act-based VoiceXML dialogue apparatus according to claim 3, further comprising a DDML editor for editing the DDML document.

5. The speech act-based VoiceXML dialogue apparatus according to claim 3, wherein the VoiceXML interpreter loads the associated speech act-based VoiceXML document from the web server and determines the response speech act information based on the associated speech act-based VoiceXML document

6. The speech act-based VoiceXML dialogue apparatus according to claim 3, wherein the DDML document represents a dialogue flow on a state basis, said state including a speech object, speech act information, and a target.

7. A speech act-based VoiceXML dialogue method, comprising the steps of:
(a) recognizing a speaker's speech and outputting the recognized result;
(b) parsing the recognized speech and extracting speech act information therefrom;
(c) loading a speech act-based VoiceXML document corresponding to the extracted speech act information from a web server and generating response speech act information based on the speech act information and the speech act-based VoiceXML document; and
(d) generating a response sentence corresponding to the response speech act information, synthesizing the sentence, and responding to the speaker.

8. The method according to claim 7, further comprising the steps of:
extracting a dialogue scenario from a dialogue database (DB) in a specific field in off-line mode;
extracting speech act information from the extracted dialogue scenario and generating the DDML document that reflects multiple dialogue flows; and
converting the DDML document into the speech act-based VoiceXML document and storing the document in the web server.

9. The method according to claim 8, further comprising the step of editing the DDML document.
